(19) United States
(12) Patent Application Publication
(10) Pub. No.: US 2011/0219681 A1
(43) Pub. Date: Sep. 15, 2011

(54) Insulated Plant Housing

(76) Inventor: Gregg Morgan STOCKWELL, Poway, CA (US)

(21) Appl. No.: 13/045,501

(22) Filed: Mar. 10, 2011

Related U.S. Application Data
(60) Provisional application No. 61/312,421, filed on Mar. 10, 2010.

(51) Int. Cl. A01G 13/02; A01G 9/02

(52) U.S. Cl. 47/20.1; 47/65.5; 47/66.1

(57) ABSTRACT

An insulated plant housing is a device extends the growing season for a plant by protecting the plant from frost damage at the beginning or end of the growing season. The device is partially filled with water to insulate the air and soil surrounding the plant from freezing temperatures at night. The device also allows the user to shroud the plant in order to protect the plant from harsh weather conditions.

The current application claims a priority to the U.S. Provisional Patent application Ser. No. 61/312,421 filed on Mar. 10, 2010.

### FIELD OF THE INVENTION

The present invention is a device used to start the growth of a plant. More specifically, the device helps to protect the newly grown plant from harsh weather conditions.

### BACKGROUND OF THE INVENTION

Traditionally, near the beginning and end of the growing season, plants are sown either by seed or seedling and need protection from frost damage. The present invention provides the plant with protection from frost damage by warming the air and soil surrounding the plant. The present invention also has a collapsible top controlled by a drawstring, which can completely insulate the plant from harsh wind, rain, or other weather conditions.

### BRIEF DESCRIPTION OF THE DRAWINGS

FIG. 1 is an exploded view of the first sheet and the second sheet.

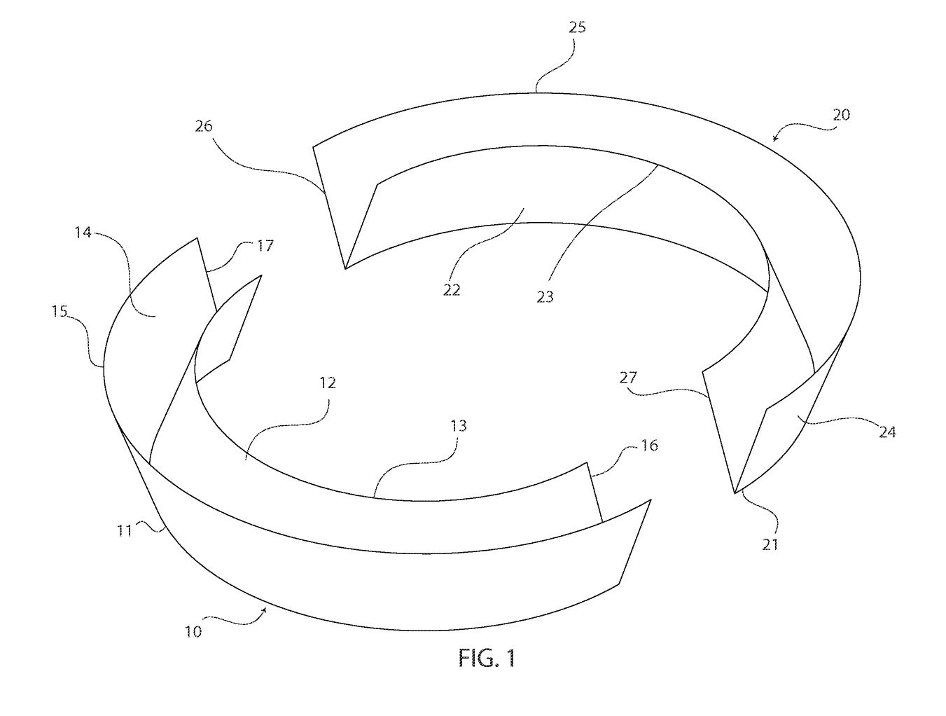

FIG. 2 is a front elevation view of the present invention.

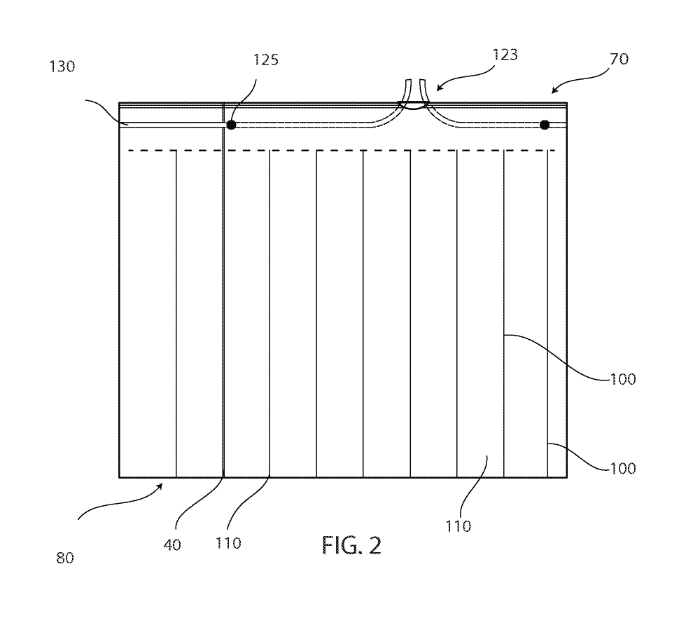

FIG. 3 is a perspective view of the present invention.

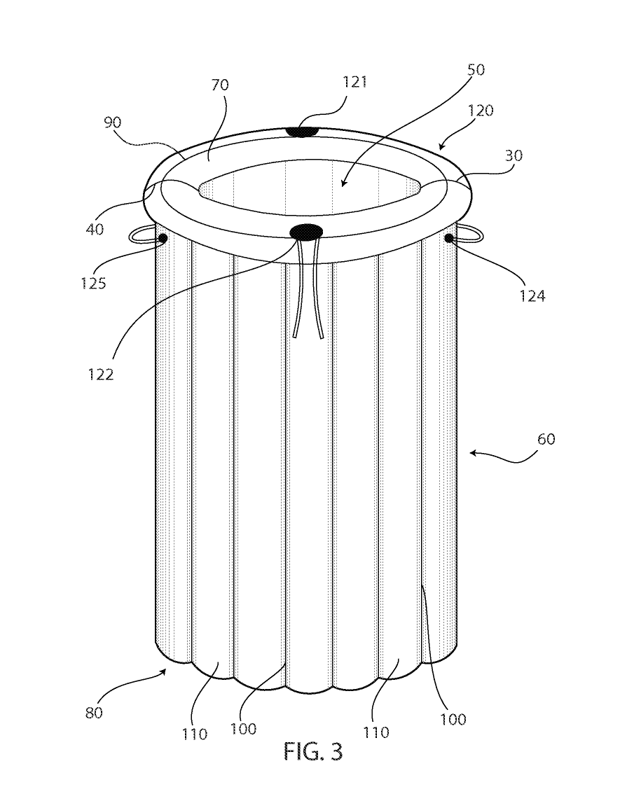

FIG. 4 is a top plan view of the present invention.

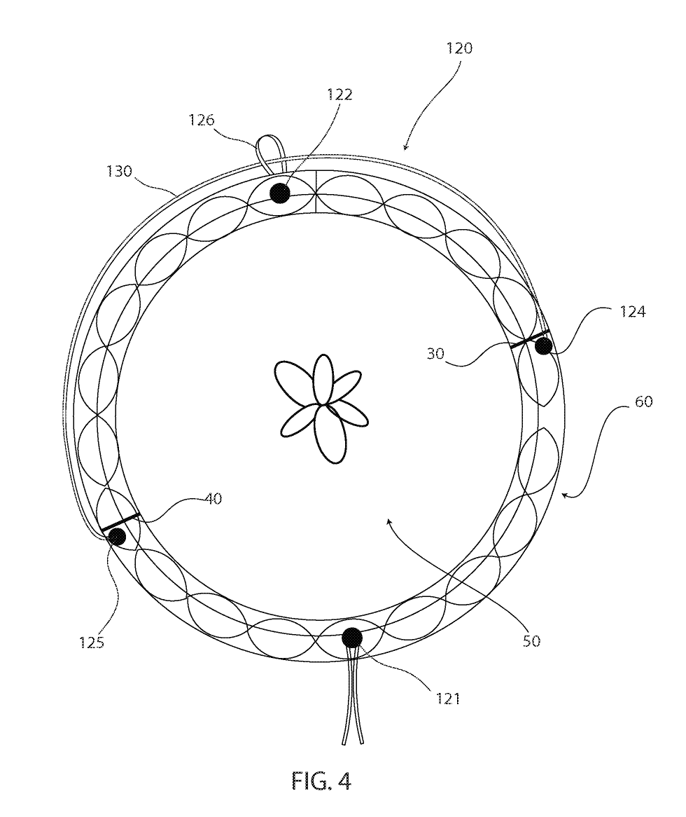

FIG. 5 is a perspective view of the present invention in use with the top connection in its full diameter.

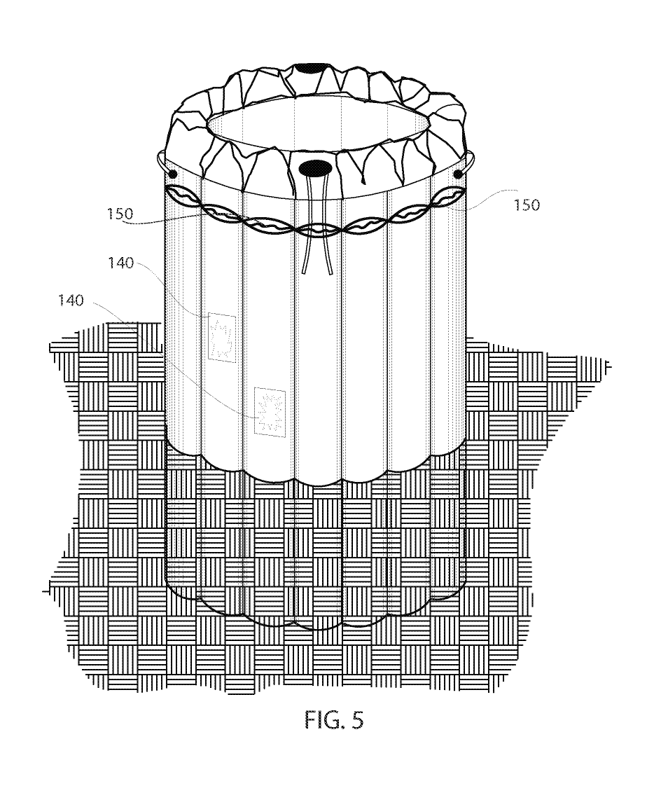

FIG. 6 is a perspective view of the present invention in use with the top connection in its minimum diameter.

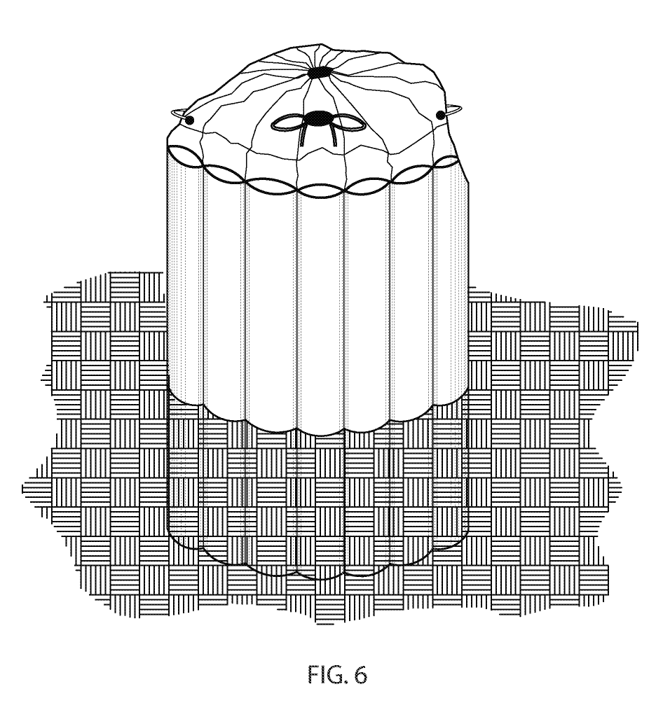

FIG. 7 is a top view of the present invention showing the path of the drawstring.

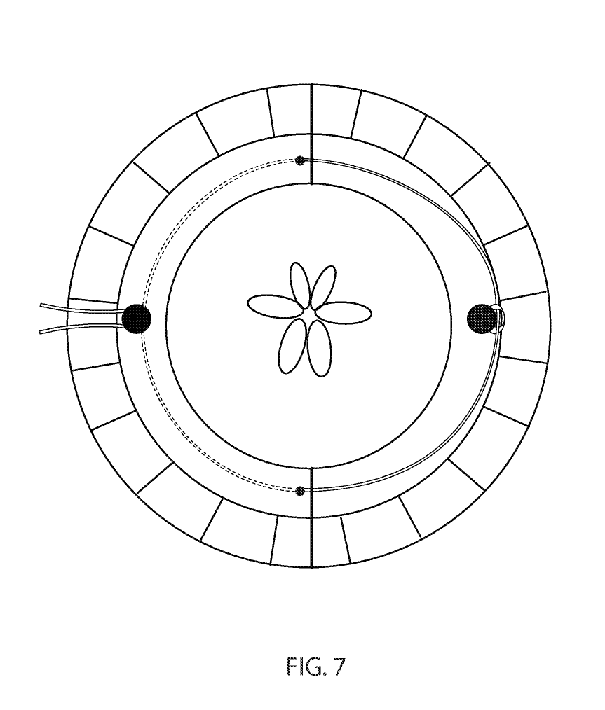

FIG. 8 is a side view of the present invention installed on a slope.

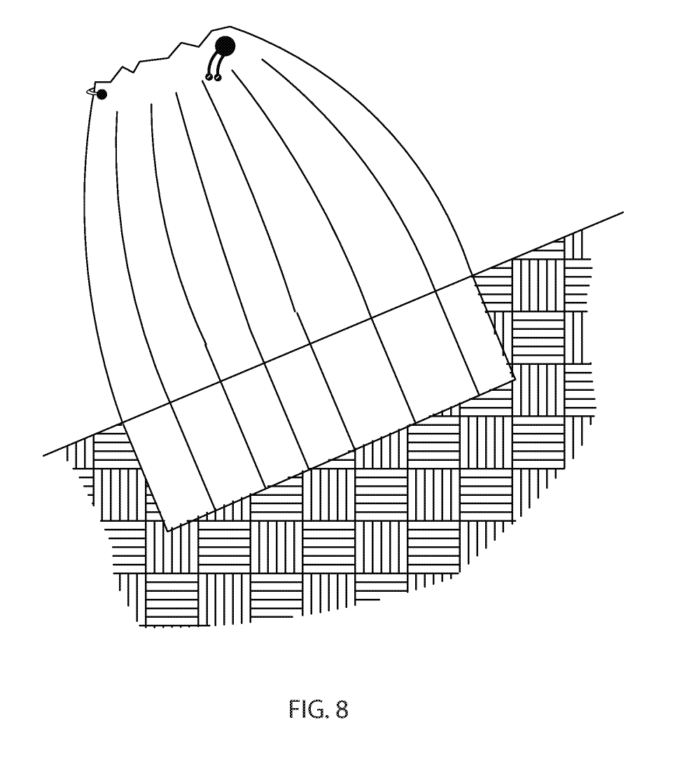

FIG. 9 is a side view of the present invention installed on a level plane.

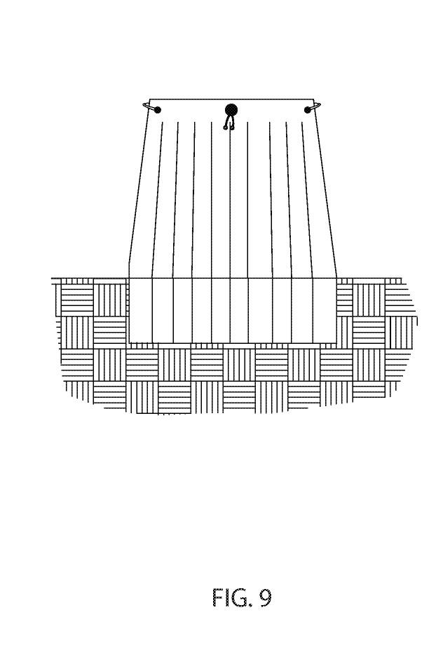

FIG. 10 is a view of the upper portion of the present invention showing the first filling hole and one of the pair of flaps.

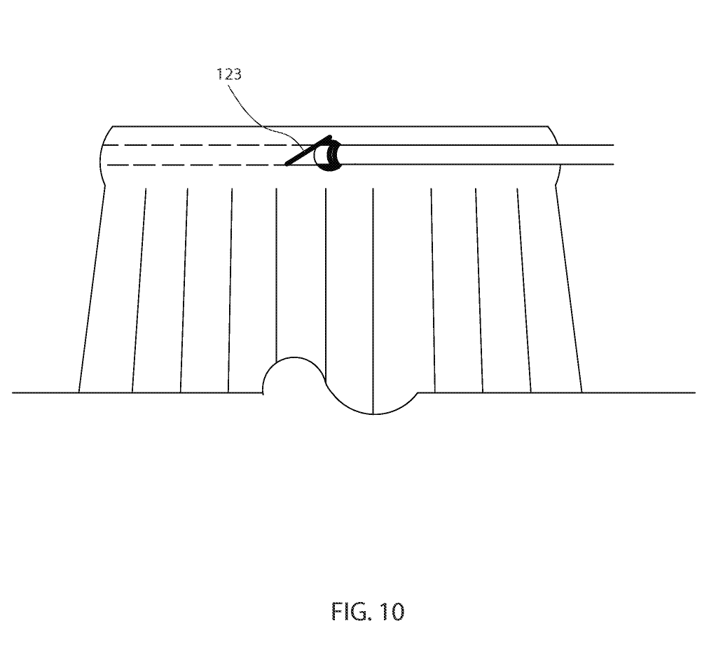

### DETAIL DESCRIPTIONS OF THE INVENTION

All illustrations of the drawings are for the purpose of describing selected versions of the present invention and are not intended to limit the scope of the present invention. The following specifications do not outline how the device should be assembled or manufactured but instead detail how the components of the device are positioned and work in relation to one another.

An insulated plant housing comprises of a first sheet 10 and a second sheet 20. The first sheet 10 and the second sheet 20 are equal in size and rectangular shape. In the preferred embodiment of the present invention, the first sheet 10 and the second sheet 20 are made of polyvinyl chloride and have an 8 mil thickness but can be 6 mil or more. The first sheet 10 and the second sheet 20 can be transparent or tinted to any combination of colors as desired by the manufacturer. The first sheet 10 is folded in half and comprises of a first bottom fold 11, a first inner half 12, a first inner top edge 13, a first outer half 14, a first outer top edge 15, a left side 16, and a right side 17. The second sheet 20 is similarly folded in half and comprises of a second bottom fold 21, a second inner half 22, a second inner top edge 23, a second outer half 24, a second outer top edge 25, a port side 26, and a starboard side 27. A first primary vertical seam 30 connects the right side 17 of the first sheet 10 to the port side 26 of the second sheet 20. The first sheet 10 and the second sheet 20 are then bent into a tubular shape so that the left side 16 of the first sheet and the starboard side 27 of the second sheet are connected at a second primary vertical seam 40.

The first primary vertical seam 30 and the second primary vertical seam 40 are formed through heat sealing, which allows the connections between the first sheet 10 and the second sheet 20 to be waterproof. The tubular shape created by the combination of the first sheet 10 and the second sheet 20 has two layers: a layer formed by the first inner half 12 and the second inner half 22 and a layer formed by the first outer half 14 and the second outer half 24. The layer formed by the first inner half 12 and the second inner half 22 forms the inner cylinder 50. The layer formed by the first outer half 14 and the second outer half 24 forms the outer cylinder 60. In the preferred embodiment, the height of the inner cylinder 50 and the outer cylinder 60 are 20″, but can range from 6″ to 36″. The first bottom fold 11 and the second bottom fold 21 form a bottom connection 80 between the inner cylinder 50 and the outer cylinder 60. The primary horizontal seam 90 permanently connects the first outer top edge 15 to the first inner top edge 13 and connects the second outer top edge 25 to the second inner top edge 23. The primary horizontal seam 90 is formed through heat sealing and forms a top connection 70 between the inner cylinder 50 and the outer cylinder 60. When this device is placed into the ground, the center axis of the inner cylinder 50 and the outer cylinder 60 are normal to the plane of the ground. From the top view in relation to the plane of the ground, the top connection 70 and the bottom connection 80 are concentric congruent circles. In the preferred embodiment, the circumference of the top connection 70 and the bottom connection 80 is 25″ to 26″, but can range from 6″ to 36″.

A plurality of secondary vertical seams 100 adhere the inner cylinder 50 to the outer cylinder 60 along lines that run normal to the plane of the ground from the bottom connection 80 to a specified distance from the top connection 70. The plurality of the secondary vertical seams 100 is heat sealed and parallel to the first primary vertical seam 30 and the second primary vertical seam 40. In the preferred embodiment, the plurality of secondary vertical seams 40 is heat sealed and run from the bottom connection 80 to 3″ away from the top connection 70, but can range from 1″ to 6″ away from the top connection 70. The plurality of secondary vertical seams 100 creates a plurality of vertical pockets 110 in between the inner cylinder 50 and the outer cylinder 60. The distance in between the plurality of secondary vertical seams 100 dictates the width of the vertical pockets 110. In the preferred embodiment, the plurality of secondary vertical seams 100 is 2.5″ apart, but can range from 0.5″ to 8″ apart. The plurality of vertical pockets 110 stores an amount of water used to insulate the soil and the air surrounding the plant. The plurality of vertical pockets 110 also allows the device to be punctured yet still function, as water will only empty out of one of the plurality of vertical pockets 110. The space between the top of the secondary vertical seams 100 and the top connection 70 form a tube 120 with the inner cylinder 50 and the outer cylinder 60. The tube 120 allows the user to evenly distribute an amount of water 150 to each of the plurality of vertical pockets 110. Water enters the tube 120 through a first filling hole 121 and a second filling hole 122 which are diametrically opposed and located on the outer cylinder 60 portion of the tube. As the tube 120 is divided into two sections by the first primary vertical seam 30 and the second primary vertical seam 40, both the first filling hole 121 and the second filling hole 122 are required to fill water into their respective sections. The first filling hole 121 and the second filling hole 122 allow the user to enter a water hose into its respective section of the tube 120. By moving the water hose in and out of the tube 120, the amount of water 150 is filled into the corresponding plurality of vertical pockets 110. From the top view, the axis of the first filling hole 121 and the second filling hole 122 is perpendicular to the axis of the first primary vertical seam 30 and the second primary vertical seam 40. In the preferred embodiment, the first filling hole 121 and the second filling hole 122 would have a 1.5″ to 2″ diameter. A pair of flaps 123 covers the first filling hole 121 and the second filling hole 122 while the first filling hole 121 and the second filling hole 122 are not being used. The pair of flaps 123 prevents mosquitoes and other insects from laying eggs and breeding in the amount of water 150 located in the plurality of vertical pockets 110. The pair of flaps 123 are adhered to the inside of the tube 120, above the first filling hole 121 and above the second filling hole 122, allowing the pair of flaps 123 to automatically close once the water hose is removed from the tube 120. A plurality of extra flaps 140 is provided with the present invention, which allows the user to substitute the plurality of extra flaps 140 as repair patches for a puncture hole. In the preferred embodiment, the pair of flaps 123 and the plurality of extra flaps 140 are also made of polyvinyl chloride and adhere to the tube 120 or the device, respectively, by a heat seal or silicone adhesive.

The tube 120 remains relatively free of water and flexible, which allows the user to use the tube 120 as a shroud to cover the plant in cases of harsh rain or wind. In order to utilize the shrouding capability of the tube 100, a drawstring 130 is threaded through the tube 100. When the drawstring 130 is pulled, the diameter of the top connection 70 shrinks to the point where the plant is completely covered. The drawstring 130 is threaded through several components located along the tube 100. The drawstring enters a first filling hole 121, travels around the inside of the tube 100, and exits the tube 100 through a first string hole 124. The first string hole 124 is located on the outer cylinder 60 just before the first vertical primary seam 30. The drawstring 130 then travels around the outer cylinder 60, through a belt loop 126, and into the second string hole 125. The belt loop 126 is located either above or below the second filling hole 122 and prevents the drawstring 130 from slipping out of position while the drawstring 130 is being pulled. The second string hole 125 is located on the outer cylinder 60 after the second primary vertical seam 40. The second string hole 125 allows the drawstring 130 to enter the section of the tube 100 in which the drawstring 130 originated. Next, the drawstring 130 travels through the tube 100 and exits out of the first filling hole 121. In the preferred embodiment, the first string hole 121 and the second string hole 122 are 0.25″ in diameter.

The installation of the insulated plant housing requires that a portion of it is buried below grade (soil). In the preferred embodiment, the bottom 6″ of the device should be buried, but can range from 1″ to 3′. In order to use the device, the user places the device in a prepared garden hole. The user then returns the soil to its original level both inside and outside the device with the plant located along the center axis of the inner cylinder 50 and the outer cylinder 60. The device is filled with water during the day and stores thermal energy from the sun. The relatively large heat capacity of water allows the device to store a relatively large amount of thermal energy. Artificial heat can also be used to warm the device. At night, the device radiates the absorbed thermal energy into the air and soil surrounding the plant. The buried portion of the insulated plant housing allows the device to withstand harsh wind or rain by providing the device with a stable foundation. The buried portion also allows the device to be installed on shallow slopes. The device only allows for the plurality of vertical pockets 110 to be filled with water because the tube's 100 shrouding ability must be kept intact. The enclosed nature of the device prevents water from spilling while the plurality of vertical pockets 110 are being filled. In areas where the availability of water is restricted, the enclosed nature of the device saves the user money on water costs, especially when the user employs multiple insulated plant housings.

Although the invention has been explained in relation to its preferred embodiment, it is to be understood that many other possible modifications and variations can be made without departing from the spirit and scope of the invention as hereinafter claimed.

What is claimed:

1. An insulated plant housing comprises of,
a first sheet;
a second sheet;
said first sheet consists of a first bottom fold, a first inner half, a first inner top edge, a first outer half, a first outer top edge, a left side, and a right side;
said second sheet consists of a second bottom fold, a second inner half, a second inner top edge, a second outer half, a second outer top edge, a port side, and a starboard side;
a first primary vertical seam;
a second primary vertical seam;
said right side connects to said port side with said first primary vertical seam; and
said left side connects to said starboard side with said second primary vertical seam.

2. The insulated plant housing as claimed in claim 1 comprises of,
an inner cylinder;
an outer cylinder;
a primary horizontal seam;
a top connection;
a bottom connection;
a primary horizontal seam;
a plurality of secondary vertical seams;
a plurality of vertical pockets;
a tube;
a drawstring; and
said tube consists of a first filling hole, a second filling hole, a pair of flaps, a first string hole, a second string hole, and a belt loop.

3. Said insulated plant housing as claimed in claim 2 comprises,
said first inner half and said second inner half form said inner cylinder;
said first outer half and said second outer half form said outer cylinder;
said primary horizontal seam connects both said first outer top edge to said first inner top edge and said second outer top edge to said second inner top edge;
said primary horizontal seam forms said top connection between said inner cylinder and said outer cylinder; and
said first bottom fold and said second bottom fold forms said bottom connection between said inner cylinder and said outer cylinder.

4. Said insulated plant housing as claimed in claim 2 comprises,
said plurality of secondary vertical seams connects said inner cylinder to said outer cylinder along lines that run from said bottom connection to a specified distance away from said top connection;
said plurality of vertical pockets being positioned between said inner cylinder and said outer cylinder; and
said plurality of vertical pockets being bordered by plurality of secondary vertical seams and bottom connection.

5. Said insulated plant housing as claimed in claim 2 comprises,
said tube is formed in between said top connection and said plurality of vertical pockets;
said first filling hole is positioned on said tube;
said second filling hole is positioned on said tube;
said first string hole is positioned on said tube;
said second string hole is positioned on said tube;
said belt loop is located on said tube below said second filling hole;
said drawstring is threaded through said first filling hole, said first string hole, said belt loop, said second string hole, and said tube; and
said pair of flaps is attached to inside tube just above said first filling hole and second filling hole.

6. Said insulated plant housing as claimed in claim 5 comprises,
said first filling hole is positioned on said first outer half;
said second filling hole is positioned on said second outer half;
said first string hole is located on said tube adjacent to said first primary vertical seam; and
said second string hole is located on said first outer half adjacent to said second primary vertical seam.

7. Said insulated plant housing as claimed in claim 2 comprises,
said plurality of vertical pockets holds an amount of water;
a plurality of extra flaps; and
said plurality of extra flaps adhere to said first sheet and said second sheet to repair said insulated plant housing.

8. An insulated plant housing comprises of,
a first sheet;
a second sheet;
said first sheet consists of a first bottom fold, a first inner half, a first inner top edge, a first outer half, a first outer top edge, a left side, and a right side;
said second sheet consists of a second bottom fold, a second inner half, a second inner top edge, a second outer half, a second outer top edge, a port side, and a starboard side;
a first primary vertical seam;
a second primary vertical seam;
said right side connects to said port side with said first primary vertical seam;
said left side connects to said starboard side with said second primary vertical seam;
an inner cylinder;
an outer cylinder;
a primary horizontal seam;
a top connection; and
a bottom connection.

9. The insulated plant housing as claimed in claim 8 comprises of,
a plurality of secondary vertical seams;
a plurality of vertical pockets;
a tube;
a drawstring; and
said tube consists of a first filling hole, a second filling hole, a pair of flaps, a first string hole, a second string hole, and a belt loop.

10. Said insulated plant housing as claimed in claim 9 comprises,
said first inner half and said second inner half form said inner cylinder;
said first outer half and said second outer half form said outer cylinder;
said primary horizontal seam connects both said first outer top edge to said first inner top edge and said second outer top edge to said second inner top edge;
said primary horizontal seam forms said top connection between said inner cylinder and said outer cylinder; and
said first bottom fold and said second bottom fold forms said bottom connection between said inner cylinder and said outer cylinder.

11. Said insulated plant housing as claimed in claim 9 comprises,
said plurality of secondary vertical seams connects said inner cylinder to said outer cylinder along lines that run from said bottom connection to a specified distance away from said top connection;
said plurality of vertical pockets being positioned between said inner cylinder and said outer cylinder; and
said plurality of vertical pockets being bordered by plurality of secondary vertical seams and bottom connection.

12. Said insulated plant housing as claimed in claim 9 comprises,
said tube is formed in between said top connection and said plurality of vertical pockets;
said first filling hole is positioned on said tube;
said second filling hole is positioned on said tube;
said first string hole is positioned on said tube;
said second string hole is positioned on said tube;
said belt loop is located on said tube below said second filling hole;
said drawstring is threaded through said first filling hole, said first string hole, said belt loop, said second string hole, and said tube; and
said pair of flaps is attached to inside tube just above said first filling hole and second filling hole.

13. Said insulated plant housing as claimed in claim 12 comprises,
said first filling hole is positioned on said first outer half;
said second filling hole is positioned on said second outer half;
said first string hole is located on said tube adjacent to said first primary vertical seam; and
said second string hole is located on said first outer half adjacent to said second primary vertical seam.

14. Said insulated plant housing as claimed in claim 9 comprises,
said plurality of vertical pockets holds an amount of water;
a plurality of extra flaps; and
said plurality of extra flaps adhere to said first sheet or said second sheet and repair said insulated plant housing.

15. An insulated plant housing comprises of,
a first sheet;
a second sheet;
said first sheet consists of a first bottom fold, a first inner half, a first inner top edge, a first outer half, a first outer top edge, a left side, and a right side;
said second sheet consists of a second bottom fold, a second inner half, a second inner top edge, a second outer half, a second outer top edge, a port side, and a starboard side;
a first primary vertical seam;
a second primary vertical seam;
said right side connects to said port side with said first primary vertical seam;
said left side connects to said starboard side with said second primary vertical seam;
an inner cylinder;
an outer cylinder;
a primary horizontal seam;
a top connection;
a bottom connection;
a primary horizontal seam;
a plurality of secondary vertical seams;
a plurality of vertical pockets;
a tube;
a drawstring; and
said tube consists of a first filling hole, a second filling hole, a pair of flaps, a first string hole, a second string hole, and a belt loop.

16. Said insulated plant housing as claimed in claim 15 comprises,
said first inner half and said second inner half form said inner cylinder;
said first outer half and said second outer half form said outer cylinder;
said primary horizontal seam connects both said first outer top edge to said first inner top edge and said second outer top edge to said second inner top edge;
said primary horizontal seam forms said top connection between said inner cylinder and said outer cylinder;
said first bottom fold and said second bottom fold forms said bottom connection between said inner cylinder and said outer cylinder;
said plurality of secondary vertical seams connects said inner cylinder to said outer cylinder along lines that run from said bottom connection to a specified distance away from said top connection;
said plurality of vertical pockets being positioned between said inner cylinder and said outer cylinder; and
said plurality of vertical pockets being bordered by plurality of secondary vertical seams and bottom connection.

17. Said insulated plant housing as claimed in claim 15 comprises,
said tube is formed in between said top connection and said plurality of vertical pockets;
said first filling hole is positioned on said tube;
said second filling hole is positioned on said tube;
said first string hole is positioned on said tube;
said second string hole is positioned on said tube;
said belt loop is located on said tube below said second filling hole;
said drawstring is threaded through said first filling hole, said first string hole, said belt loop, said second string hole, and said tube;
said pair of flaps is attached to inside tube just above said first filling hole and second filling hole.
said first filling hole is positioned on said first outer half;
said second filling hole is positioned on said second outer half;
said first string hole is located on said tube adjacent to said first primary vertical seam;
said second string hole is located on said first outer half adjacent to said second primary vertical seam;
said plurality of vertical pockets holds an amount of water;
a plurality of extra flaps; and
said plurality of extra flaps adhere to said insulated plant housing and repair said insulated plant housing.

18. Said insulated plant housing as claimed in claim 15 comprises,
said plurality of vertical pockets holds an amount of water;
a plurality of extra flaps; and
said plurality of extra flaps adhere to said first sheet or said second sheet and repair said insulated plant housing.
